(19) United States
(12) Patent Application Publication
(10) Pub. No.: US 2018/0330071 A1
(43) Pub. Date: Nov. 15, 2018

(54) ENTRY SYSTEM WITH A PORTABLE AUTHORIZATION APPARATUS

(71) Applicant: AUDI AG, Ingolstadt (DE)

(72) Inventor: Roman STRAßER, Gaimersheim (DE)

(73) Assignee: AUDI AG, Ingolstadt (DE)

(21) Appl. No.: 15/773,692

(22) PCT Filed: Jul. 22, 2016
(86) PCT No.: PCT/EP2016/001280

§ 371 Date: May 4, 2018

(30) Foreign Application Priority Data
Nov. 6, 2015 (DE) 10 2015 014 366.2

(51) Int. Cl. G06F 21/35; G06Q 20/32; H04W 12/06; H04W 12/08; G07C 9/00

(52) U.S. Cl. CPC G06F 21/35; G06Q 20/3278; G07C 2009/00865; H04W 12/08; G07C 9/00857; H04W 12/06

(57) ABSTRACT

An entry system with a portable authorization apparatus that is designed to authorize entry to a motor vehicle and a payment function, and with a database apparatus, in which data required for authorizing entry to the motor vehicle and to the payment function are storable. The database apparatus is designed as part of the entry system separate from the authorization apparatus, and the authorization apparatus includes a radio device, by which the data required for the authorization are wirelessly retrievable from the database apparatus.

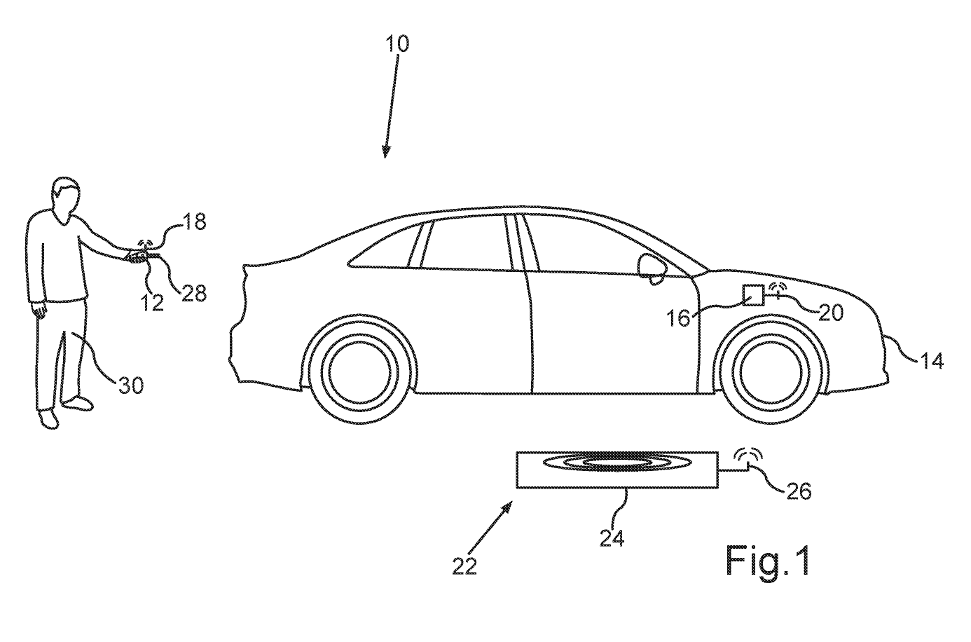

The invention relates to an entry system according to the preamble of patent claim 1. In addition, the invention relates to a method for operating an entry system according to the preamble of patent claim 10.

A motor vehicle key having a key body, a data medium unit, and an electronics unit that is arranged in the key body is known from DE 10 2011 118 156 A1. The data medium unit is arranged in a moveable manner at the key body, between a protected position in which a contact interface of the data medium unit is protected against mechanical damage by the key body, and a contacting position, in which the contact interface can be contacted in such a way that an electrical contact between the data medium unit and the electronics unit exists both in the protected position and in the contacting position.

A payment apparatus that a motor vehicle comprises is known from US 2013/0085928 A1. This motor vehicle has a unique identification feature, by means of which an account belonging to it can be identified in the case of a payment.

A motor vehicle key that has a locking device for interaction with a motor vehicle lock is known from DE 10 2011 013 598 A1. In addition, the motor vehicle key has an electronic data memory for the storage of payment information and a device for the wireless transmission of payment information to an external receiver.

An important requirement of entry systems, by means of which both an entry to a motor vehicle as well as a payment function can be authorized, is the security thereof against unauthorized access. The object of the present invention is to create an entry system of the kind indicated above, which is particularly protected against any unauthorized use. In addition, the object of the present invention is to create a method for operating an entry system, by means of which any unauthorized use can be particularly reliably prevented.

These objects are achieved according to the invention by an entry system with the features of patent claim 1 and by a method with the features of patent claim 10. Advantageous embodiments with appropriate enhancements of the invention are indicated in the respective dependent claims, wherein advantageous embodiments of the entry system are to be viewed as advantageous embodiments of the method, and vice versa.

A first aspect of the invention relates to an entry system with a portable authorization apparatus that is designed to authorize entry to a motor vehicle and to a payment function, and with a database apparatus, in which data required for authorizing entry to the motor vehicle and to the payment function are storable. Therefore, a motor vehicle can be opened by means of the authorization apparatus. In addition, a payment can also be effected, for example, at a gas station, with the authorization apparatus.

Here, it is provided according to the invention that the database apparatus is designed as a part of the entry system separate from the authorization apparatus, and the authorization apparatus comprises a radio device, by means of which the data required for the authorization are wirelessly retrievable from the database apparatus. The data may involve, for example, electronic authorization certificates. It is to be provided here independently that the database apparatus, for example, is not accommodated together with the authorization apparatus in one housing. The database apparatus thus involves an autonomous component separate from the authorization apparatus. It is possible thereby to store the database apparatus protected against manipulation. For example, the database apparatus can be part of the motor vehicle. In particular, the database apparatus can be enclosed in an interior space of the motor vehicle. Then the database apparatus cannot be directly manipulated by unauthorized persons if they gain possession of the authorization apparatus. The entry system is particularly protected from any unauthorized access in this way.

The radio device can be designed, for example, as a so-called NFC device, i.e., as a near field communication device, as an RFID chip, and/or as a radio device for the transmission of data by means of Bluetooth. In particular, with the use of Bluetooth, the radio device, and with it the authorization apparatus, can also be coupled to other apparatuses. For example, the authorization apparatus can be coupled to the Bluetooth keyboard for the operation thereof. Another example of an equipment coupling is a so-called headset, by way of which acoustic feedback can then be emitted acoustically relating to a successful authorization of entry to the motor vehicle or to the payment function. The radio device can also be designed for the purpose of sending data to the database apparatus. For example, with a successful payment, data regarding the authorized transaction can be sent to the database apparatus. This data can then be saved in the database apparatus, for example, in order to update the status of an account.

In another advantageous embodiment of the entry system according to the invention, it is provided that the radio device is designed alternatively or additionally for the purpose of retrieving the information from the database apparatus by means of a wireless communication standard for mobile phones. Such a wireless communication standard, for example, can refer to GPRS, Edge, GSM, UMTS, HSDPA; H+. HSPA+, LTE and/or LTE Advanced. With the use of a wireless communication standard, the respective data can be transmitted over distances of nearly any length. It is possible therewith to accommodate the database apparatus protected very remotely, for example, in a building. In particular, the database apparatus can be part of a particularly secure network of a bank and/or a specialized company. In addition, particular accounts can be directly charged with the use of the payment function. It is then no longer necessary that a point-of-sale facility, such as a gas station, for example, makes a connection to a bank in order to be able to confirm payment.

The payment function can thus be used with a high degree of autonomy. The wireless communication standard also involves particularly protected transmission standards, which can be continuously enhanced. In this way, the entry system can also be particularly well protected against any unauthorized interception of any particular transmitted data.

In another advantageous embodiment of the entry system according to the invention, it is provided that the radio device is designed for the purpose of providing the functionality of a mobile phone. It is then no longer necessary for a user of the entry system to carry a mobile phone in addition to the authorization apparatus in order to be able to make telephone calls. The entry system can thus replace, as it were, a mobile phone, a credit card, and/or other payment cards, and thus also a purse or wallet can be replaced by the portable authorization apparatus. At the same time, the entry system can also provide the user with access to his/her motor vehicle.

In another advantageous embodiment of the entry system according to the invention, it is provided that the authorization apparatus is designed as a motor vehicle key. Therefore, the authorization apparatus has the function—directly recognizable by the user—of providing him/her with entry to his/her vehicle. In this case, the authorization apparatus can also comprise additional elements of an auto key, such as, for example, a key part. Thus, an ignition of the motor vehicle can then be activated in the usual way. In this case, the auto key can be configured so that third parties cannot recognize that it can be used for making payment. In this way, the security of the entry system is particularly high.

In another advantageous embodiment of the entry system according to the invention, it is provided that the entry to the motor vehicle and/or to the payment function can be authorized wirelessly by means of the radio device of the authorization apparatus. For example, the radio device can send a signal to the motor vehicle when it approaches the latter. Then, the motor vehicle can be opened as a function of this signal. Alternatively or additionally, the entry can also be triggered by an actuation of the authorization apparatus. In this case, the authorization apparatus need no longer be brought into contact with the motor vehicle itself.

The same is possible for the payment function. For example, the user of the entry system can confirm wirelessly in advance the payment to a gas station by means of the authorization apparatus. For this purpose, the driver or user need no longer leave his vehicle. In particular, at a service station for electric vehicles, which may also be referred to as charging stations, a recharging of the motor vehicle can be automatically effected, for example, by means of inductive coils in the ground. In this case, the user of the entry system generally no longer needs to leave the vehicle in order to recharge the vehicle. Therefore, the user can remain protected in his/her vehicle, so that, for example, he/she cannot be robbed without further action during the filling or recharging, respectively, of the motor vehicle. If the radio device is designed for the purpose of providing access to the database apparatus by means of the wireless communication standard, in this case, the gas station or charging station, respectively, does not even once need to make a connection to a corresponding bank or equivalent for confirming the payment. This can be carried out by the authorization apparatus itself.

In another advantageous embodiment of the entry system according to the invention, it is provided that the entry system comprises an authentication apparatus, by means of which the authorization apparatus is releasable for authorizing entry to the vehicle and to the payment function, and/or by means of which the retrieval of data and/or a change in the data of the database apparatus is releasable. For example, the user can enter a PIN in an operating field in order to be authenticated in the case of the entry system. Therefore, the entry system is also protected against any unauthorized access in the case of an accidental loss or theft of the authorization apparatus. The authentication apparatus in this case can be a part of the authorization apparatus.

In another advantageous embodiment of the entry system according to the invention, it is provided that the authentication apparatus comprises a fingerprint sensor and/or an image capture device for identifying a person authorized to use the entry system. Due to the use of biometric features, an authorized user can be particularly reliably authenticated. Respective identifying features of authorized persons can be stored in this case in the authentication apparatus and/or the database apparatus. In particular, by storing these identifying features, which can also be referred to as identification features, in the database apparatus, they can be securely stored and managed centrally. Therefore, the number of persons with authorized entry to a company car, for example, can be any number, and can be rapidly and reliably changed centrally as needed. If the identifying features are stored in the authentication apparatus itself, the radio device can be blocked in an advantageous way against a successful authentication.

In another advantageous embodiment of the entry system according to the invention, it is provided that the database apparatus and/or the authentication apparatus is designed for the purpose of storing entry authorizations specific to the person for the particular functions of the entry system. For the functions of the entry system, user profiles, which can also be called User Profiles, can thus be created. For example, only entry to the motor vehicle can be released as a function to one user, whereas for another user, both entry to the motor vehicle as well as to the payment function will be released as functions. In this way, for example, it is possible in a simple way to lend the motor vehicle to one person, but this person is not able to use the car key for payments. It is likewise possible to configure the entry authorizations specific to the person, so that a different account will be charged with the use of the payment function for each person authorized for entry.

In another advantageous embodiment of the entry system according to the invention, it is provided that an entry to a building, an access to a computer, an access to a computer network, and/or a transmission of data stored in the database apparatus to a data processing device can be authorized by means of the authorization apparatus. The entry system can thus be utilized, for example, for the purpose of managing particular entry authorizations in a company, for example, to a company vehicle fleet, and/or to particular work areas. Likewise also, in the case of a user at home, the entry system can also be used by this user for the purpose of gaining entry to his/her house. In this case, the entry system with the portable authorization apparatus also replaces a house door key. By authorizing the transmission of data stored in the database apparatus to a data processing device, the entry system can also be utilized for managing additional data. For example, particular data of an identity card, a driver's license, and/or a health insurance card can also be entered into the database apparatus. These cards then no longer need to additionally be carried by users. For example, the portable authorization apparatus can be utilized for the purpose of transmitting particular data necessary for a doctor visit to the doctor or to a data processing device of the doctor. Likewise, for example, particular credit information can also be saved in the database apparatus. Then the authorization apparatus can be utilized, for example, for the purpose of requesting credit.

A second aspect of the invention relates to a method for operating an entry system with a portable authorization apparatus and with a database apparatus separate from the authorization apparatus. In this case, for operating the entry system, it is provided to retrieve data that is necessary for authorizing an entry to a motor vehicle and authorizing a payment function from the database apparatus wirelessly by means of a radio device of the authorization apparatus and to transmit the data to the authorization apparatus. After this, the entry and/or the payment function is/are authorized by means of the authorization apparatus, depending on the retrieved and transmitted data. Due to the separation of the database apparatus from the authorization apparatus, the entry system is particularly well protected against any unauthorized access. In particular, the authorization apparatus can be locked without problem in the event of a loss thereof. For example, for such locking, a transmission and/or a retrieval of the data required in the database apparatus to and/or by way of the authorization apparatus can be blocked. For this, it can be provided that the authorization apparatus is identified by means of a clearly assignable identification number or another identification feature in the database apparatus for the retrieval of the data.

Other advantages, features and details of the invention result from the following description of a preferred example of embodiment and based on the drawing. The features and combinations of features named in the preceding description, as well as the features and combinations of features named below in the description of the figures and/or features and combinations of features shown in the FIGURE alone can be used not only in the particular combination indicated in each case, but also in other combinations or standing alone, without departing from the scope of the invention.

In a schematic view, the single FIGURE shows an entry system, by means of which entry to a motor vehicle and to a payment function are authorizable.

In a schematic view, the single FIGURE shows an entry system 10 with a portable authorization apparatus 12 that is designed for the purpose of authorizing entry to a motor vehicle 14 and a to payment function, and with a database apparatus 16, in which data required for authorizing entry to the motor vehicle 14 and the payment function can be stored. The entry system 10 may also be called an authorization system. The database apparatus 16 in this case is designed as part of the entry system 10 separate from the authorization apparatus 12. For example, the database apparatus 16 is arranged in an interior space of the motor vehicle 14, protected against unauthorized access. The authorization apparatus 12 comprises a radio device 18, by means of which the data required for the authorization are wirelessly retrievable from the database apparatus 16. For this, the database apparatus 16 also comprises a corresponding radio device 20. Therefore, with a loss of the authorization apparatus 12, the database device itself cannot be acted on. At the same time, the retrieval of data from the database apparatus 16 by means of the authorization apparatus 12 can be blocked, for example, by another authorization apparatus or blocked at the database apparatus 16.

The database apparatus 16 can also be arranged inside a building. For example, the database apparatus 16 can be part of a protected network of a bank. For this, the radio device 18 is designed for the purpose of retrieving information from the database apparatus 16 by means of a wireless communication standard for mobile phones.

Since the radio device 18 is designed for the purpose of transmitting data by means of the wireless communication standard for mobile phones, the functionality of a mobile phone can also be provided by means of the authorization apparatus 12. For this, the authorization apparatus 12 may comprise particular microphones, speakers and operating elements.

The authorization apparatus 12 can be designed here in the form of a motor vehicle key. In particular, the authorization apparatus 12 can still comprise mechanical and/or electromechanical elements such as a key part for activating an ignition of the motor vehicle 14.

It is also possible to wirelessly authorize entry to the motor vehicle 14 and/or to the payment function by means of the radio device 18 of the authorization apparatus 12. For example, for this, when it is actuated, the authorization apparatus 12 can open the motor vehicle 14 without the need for the authorization apparatus 12 to be in contact with the motor vehicle 14. Likewise, for example, payment to a service station can be authorized without contact. The service station may comprise, for example, a charging station 22 having an induction coil 24. This induction coil 24 can recharge a motor vehicle 14 designed as an electric vehicle without making contact, if the vehicle is parked over it—as shown in the FIGURE. Activation of the charging can be effected wirelessly by radio by way of an authorization of a payment by means of the authorization apparatus 12. For this purpose, the charging station 22 also comprises a radio device 26. The driver of the motor vehicle 14 thus need no longer leave the vehicle for a recharging. Instead of this, the driver can remain protected, enclosed in the motor vehicle 14.

In addition, the entry system 10 comprises an authentication apparatus 28, by means of which the authorization apparatus 12 is releasable for authorizing entry to the motor vehicle 14 and to the payment function, and by means of which the retrieval and/or a change of data in the database apparatus 16 is permissible. For example, for this purpose, a PIN can be entered into the authentication apparatus 28. The authentication apparatus 28 in this case can be part of the portable authorization apparatus 12 and can unlock the use thereof.

Therefore, the entry system 10 is particularly secure, if the authentication apparatus 28 can comprise a fingerprint sensor and/or an image capture device for identifying persons authorized to use the entry system 10. Thus, for example, particular biometric features for a person 30 who is authorized for entry can be detected by means of the portable authentication apparatus 28. For this, the authentication apparatus 28 can comprise a camera, for example.

The database apparatus 16 and/or the authentication apparatus 28 can be designed in this case for the purpose of storing person-specific entry authorizations for the respective functions of the entry system 10. For example, for a specific person, the latter may be permitted to use the entry system 10 or the authorization apparatus 12, respectively, only for entry to the motor vehicle 14. In this way, the motor vehicle 14 with the authorization apparatus 12 can be loaned out, but this person cannot then make purchases at the owner's expense. Another person, for example the owner, in contrast to this, can be authorized to utilize the authorization apparatus 12 both for entry to the motor vehicle 14 and for paying for recharging at the charging station 22. The person-specific entry authorizations can also be designed for the purpose that, when the payment function is used, different accounts will be charged, depending on the user in each case. Then, for a payment by means of the authorization apparatus 12, the account assigned to the authorized person can be charged in each case.

The authorization apparatus 12 or the entry system 10, respectively, can also be utilized for the purpose of authorizing an entry to a building, an access to a computer, an access to a computer network, and/or a transmission of data stored in the database apparatus 16 to a data processing device. Therefore, the entry system 10 and the authorization apparatus 12 can be utilized, for example, for all entry authorizations of a company and the entire vehicle fleet thereof. Likewise, the entry system 10 can be utilized for the purpose of providing, for example, information of an identity card or a health insurance card.

The entry system 10 or the authorization apparatus 12, respectively, is designed for the purpose of making possible a contact-free entry to the motor vehicle 14. This is also called a keyless entry or keyless go. At the same time, the entry system 10 or the authorization apparatus 12 can also be used for the purpose of making possible a keyless entry for house doors in the private sector. For this, the radio device 18 can also comprise an RFID chip. In this case, it is no longer necessary to utilize different entry devices for different entry and authentication or authorization systems, respectively. The entry system 10 or the portable authorization apparatus 12 thus replaces, for example, a car key, a purse or wallet containing cash, an EC card, a credit card, a mobile wireless device, which can also be called a mobile phone, and other authentication items, such as, for example, an identity card. The functionalities of these items and devices have thus been incorporated into an authorization system of a car key.

1-13. (canceled)

14. An entry system comprising:
a portable authorization apparatus that is designed to authorize entry to a motor vehicle and to a payment function, and having a database apparatus, in which data required for authorizing entry to the motor vehicle and to the payment function are storable, wherein the database apparatus is designed as a part of the entry system separate from the authorization apparatus, and the authorization apparatus includes a radio device, by which the data required for the authorization are wirelessly retrievable from the database apparatus.

15. The entry system according to claim 14, wherein the radio device is designed for the purpose of retrieving the information from the database apparatus by a wireless communication standard for mobile phones.

16. The entry system according to claim 15, wherein the radio device is designed for the purpose of providing the functionality of a mobile phone.

17. The entry system according to claim 14, wherein the authorization apparatus is designed as a motor vehicle key.

18. The entry system according to claim 14, wherein entry to the motor vehicle and/or to the payment function is authorizable wirelessly by the radio device of the authorization apparatus.

19. The entry system according to claim 14, wherein the entry system includes an authentication apparatus, by which the authorization apparatus is releasable for authorizing the entry to the motor vehicle and to the payment function, and/or by which the retrieval of and/or a change in the data of the database apparatus is releasable.

20. The entry system according to claim 19, wherein the authentication apparatus includes a fingerprint sensor and/or an image capture device for identifying a person authorized to use the entry system.

21. The entry system according to claim 19, wherein the database apparatus and/or the authentication apparatus is/are designed for the purpose of storing person-specific entry authorizations for particular functions of the entry system.

22. The entry system according to claim 14, wherein an entry to a building, an access to a computer, an access to a computer network, and/or a transmittal of data stored in the database apparatus to a data processing device is/are authorizable by the authorization apparatus.

23. A method for operating an entry system with a portable authorization apparatus and with a database apparatus, separate from the authorization apparatus, comprising:
wireless retrieval of and transmittal of data that are required for authorizing entry to a motor vehicle and authorizing a payment function, from the database apparatus to the authorization apparatus by a radio device of the authorization apparatus;
authorization of entry to the motor vehicle and/or authorization for the payment function, depending on the retrieved and transmitted data by means of the authorization apparatus.
